(19) United States
(12) Patent Application Publication
(10) Pub. No.: US 2016/0089645 A1
(43) Pub. Date: Mar. 31, 2016

(54) Devices for Cleaning Automated Blenders

(71) Applicant: Cornelius, Inc., St. Paul, MN (US)

(72) Inventors: Jonathan Wirkus, St. Charles, IL (US); Richard Schultz, Niles, IL (US); Nicholas M. Giardino, Gilberts, IL (US); Hansel Sjukur, Urbana, IL (US)

(73) Assignee: CORNELIUS, INC., St. Paul, MN (US)

(21) Appl. No.: 14/858,623

(22) Filed: Sep. 18, 2015

Related U.S. Application Data
(60) Provisional application No. 62/055,903, filed on Sep. 26, 2014.

(51) Int. Cl. B01F 15/00

(52) U.S. Cl. CPC B01F 15/00045

(57) ABSTRACT

A device is for cleaning an automated blender that includes a body that axially extends between a first end and a second end. The automated blender includes a base, a blender blade that axially moves towards and away from the base, and a splash shield that moves between a closed position and an open position. The first end of the body configured to receive the blender blade when the blender blade moves toward the base. The rotation of the blender blade causes rotation of the body which cleans an interior surface of the splash shield. The device may also include an alignment portion and a bearing which allows the body to translate radially as the body rotates. The device may also include a retainer plate coupled with the body which allows the body to translate vertically with respect to the bearing.

### CROSS-REFERENCE TO RELATED APPLICATION

This application claims the benefit of and priority to U.S. Provisional Patent Application No. 62/055,903, filed Sep. 26, 2014, which is hereby incorporated by reference in entirety.

### FIELD

The present disclosure relates to devices for cleaning automated blenders.

### BACKGROUND

The following U.S. Patent is hereby incorporated by reference in entirety.

U.S. Pat. No. 8,807,823 discloses an automated blend in-cup apparatus and the related method of operation. The disclosure relates generally to the field of mixing consumable material. More specifically, the disclosure relates to a mixer that is automatically operable to lower a mixing blade into a cup or vessel that contains material to be blended/mixed. A shield is automatically lowered to at least partially isolate the cup. After mixing, the shield and blade are automatically retracted, and the cup is removed from the apparatus. The shield and blade may be automatically lowered again for a cleaning operation. Use of the apparatus can be accomplished with one hand. Overall, the apparatus contains various structural and safety elements that provide a unique construction and method of operating the apparatus. The apparatus is effective, fast, easy to operate, safe, and clean.

### SUMMARY

The Summary is provided herein to introduce a selection of concepts that are further described herein below in the Detailed Description. This summary is not intended to identify key or essential features from the claimed subject matter, nor is it intended to be used as an aid in limiting the scope of the claim subject matter.

In certain examples, a device for cleaning an automated blender includes a body that axially extends between a first end and a second end. The automated blender includes a base for supporting a cup, a blender blade that axially moves towards and away from the base, and a splash shield that moves between a closed position enclosing the cup and an open position exposing the cup. The first end of the body is configured to face the blender blade and the second end is configured to face the base. The first end is further configured to receive the blender blade when the blender blade is moved towards the base such that rotation of the blender blade causes rotation of the body, which cleans an interior surface of the splash shield.

In certain examples, a device for cleaning an automated blender includes a body, an alignment portion, and a bearing. The automated blender includes a base for supporting a cup, a blender blade that axially moves towards and away from the base, and a splash shield that moves between a closed position enclosing the cup and an open position exposing the cup. The body of the device axially extends between a first end and a second end, such that in use the first end is configured to face the blender blade and the second end is configured to face the base. An alignment portion is connected the second end of the body and configured to align the body with respect to the base when the device is inserted into the automated blender. A bearing includes a radially inner bearing surface that defines a recess. The alignment portion nests in the bearing such that the alignment portion abuts the radially inner bearing surface and is pivotable with respect to the bearing. The body is rotated by the blender blade to clean the interior surface of the splash shield.

### BRIEF DESCRIPTION OF THE DRAWINGS

Examples are described with reference to the following drawing figures. Like reference numbers are used throughout the figures to reference like features and components.

FIG. 1 depicts a front perspective view of an automated blender having a splash shield in an open position exposing a device according to the present disclosure.

FIG. 2 depicts a front perspective view of the automated blender depicted in FIG. 1 with the splash shield in a closed position enclosing the device. A cut-way of the splash shield is also depicted to show the device and a blender blade moving toward a base of the automated blender.

FIG. 3 depicts a partial cross-sectional view of the automated blender and the device shown in FIG. 2, along line 3-3.

FIG. 4 depicts a device of the present disclosure and a base of the automated blender.

FIG. 5 depicts an exploded view of the device shown in FIG. 4.

FIG. 6 depicts a cross-sectional view of the device shown in FIG. 4, along line 6-6.

### DETAILED DESCRIPTION

In the present disclosure, certain terms have been used for brevity, clearness and understanding. No unnecessary limitations are to be implied therefrom beyond the requirement of the prior art because such terms are used for descriptive purposes only and are intended to be broadly construed. The different devices and methods described herein may be used alone or in combination with other devices and methods. Various equivalents, alternatives and modifications are possible within the scope of the appended claims.

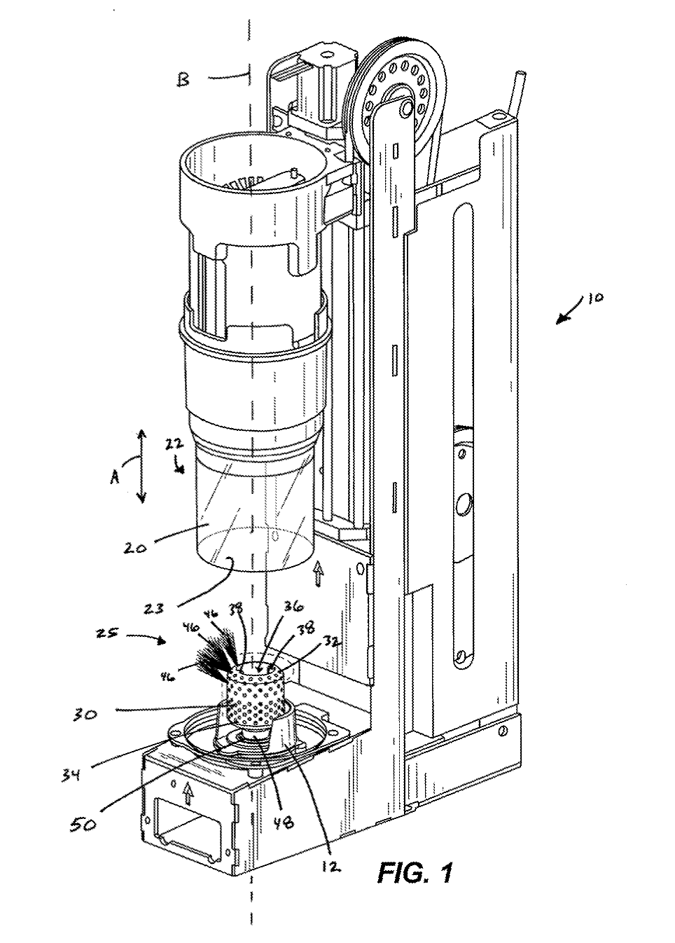

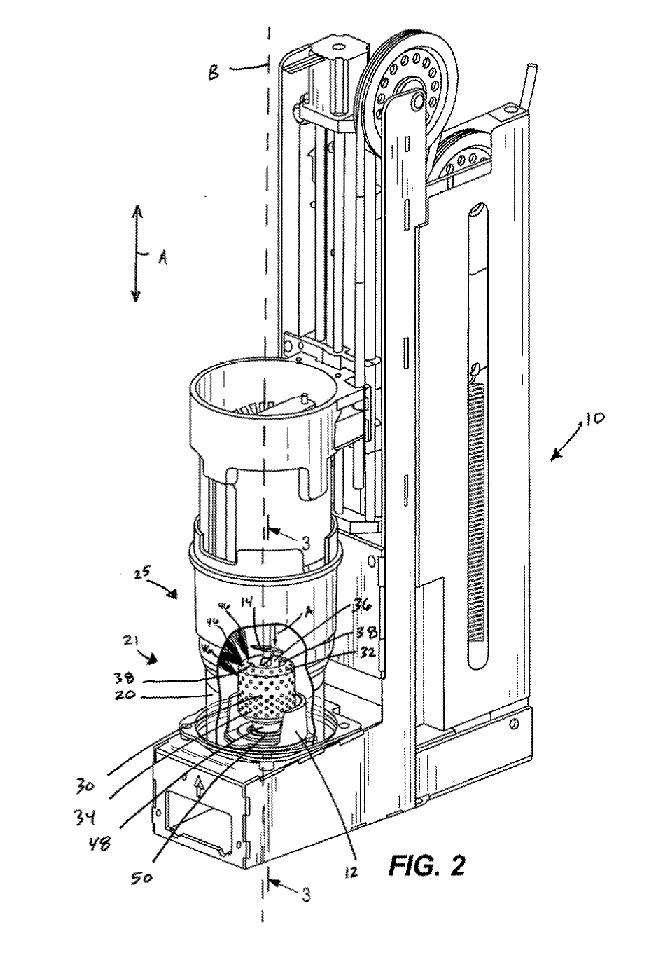

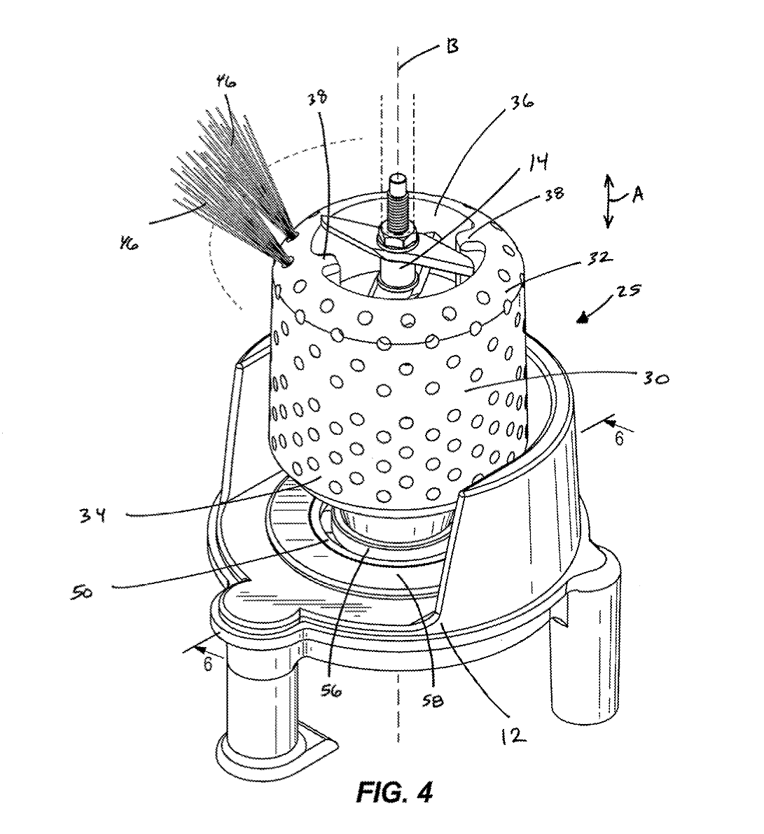

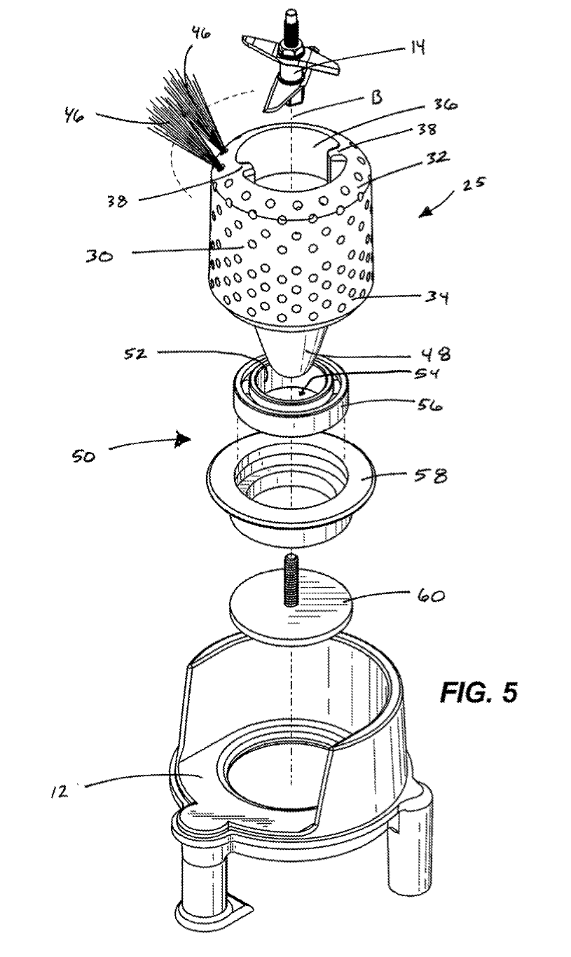

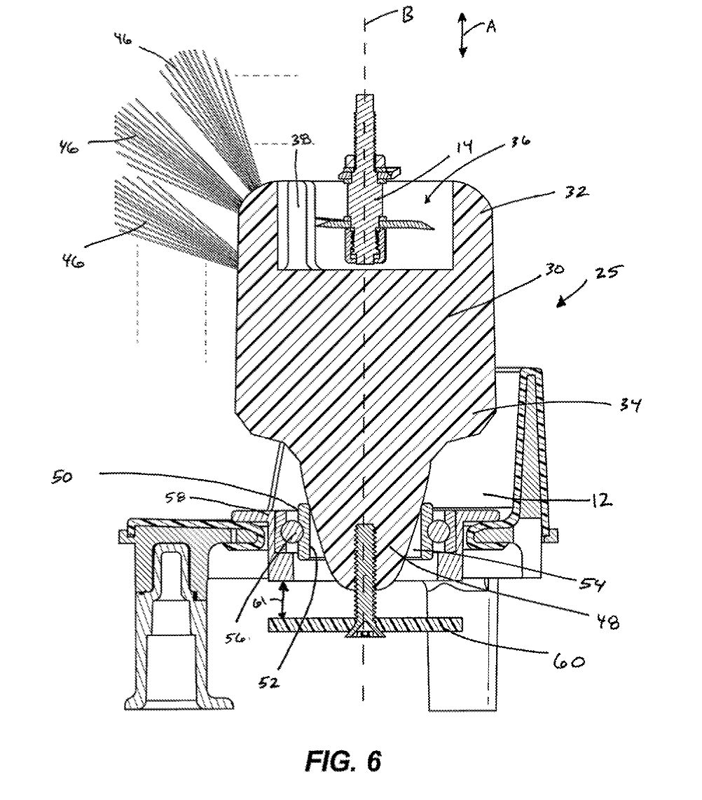

FIGS. 1-6 depict a device 25 for cleaning an automated blender 10. The automated blender 10 includes a base 12 for supporting a cup (not shown), a blender blade 14 capable of moving in an axial direction A towards and away from the base 12, and a splash shield 20 that moves between a closed position 21 enclosing the cup (FIG. 2) and an open position 22 exposing the cup (FIG. 1). The automated blender 10 is of a known type used in commercial restaurants for blending frozen beverages, fruit beverages, and other blended beverages. One exemplary automated blender 10 is manufactured by Hamilton Beach, model number 1M12000-CE, Type GM42. The incorporated U.S. Pat. No. 8,807,823 discloses another example of an automated blender 10.

The base 12 may include a cup holder having an opening. It is further contemplated that the base 12 may include, a plurality of support legs, or the base 12 may be another portion of the automated blender 10. The exact configuration of the automated blender 10 can vary from that which is shown and is not critical.

Through experimentation and research, the present inventors have determined that it can be difficult to clean the inside surfaces 23 of the splash shield 20 after a beverage has been blended in the automated blender 10. The food product located in the cup often splashes out of the cup as the blender blade 14 rotates and/or moves into or out of the cup. The splash shield 20 prevents the food product from splashing, into other surfaces and/or areas around the automated blender 10.

It is known in the art to spray water or cleaning solution on the inside surfaces 23 of the splash shield 20. However, the present inventors have recognized that spraying water or cleaning solution on the inside surfaces 23 of the splash shield 20 may not clean all of the food product from the inside surfaces 23 especially if the food product is stuck, adhered to, and/or dried on various hard-to-reach inside surfaces 23 of the splash shield 20. These conditions can make it difficult to ensure the sanitary and cleanliness of the automated blender 10 for subsequent beverages blended in the automated blender 10.

FIG. 1 depicts the splash shield 20 in an open position 22 and the device 25 positioned between the base 12 and the blender blade 14 (not shown in FIG. 1, see FIG. 2). FIG. 2 depicts the splash shield 20 in a closed position 21 and the blender blade 14 moving toward the base 12 along an axis a The blender blade 14 may move toward the base 12 as the splash shield 20 moves from the open position 22 (FIG. 1) to the closed position 21 (FIG. 2) or subsequent to the movement of the splash shield 20.

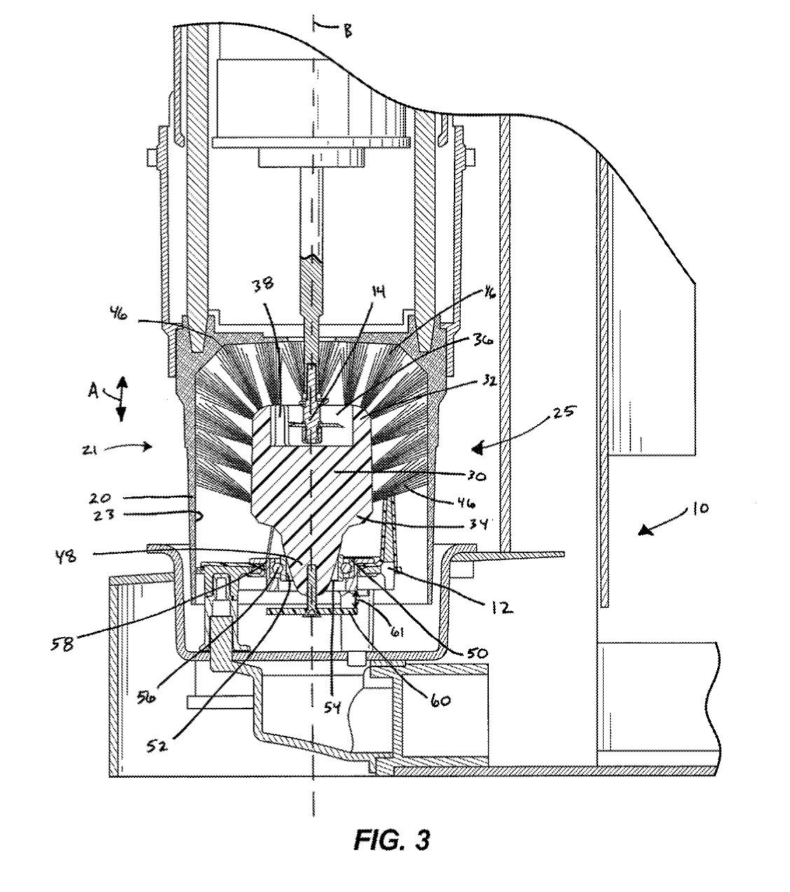

In particular, FIGS. 3-6 depict one example of the device 25, according to the present disclosure, which is configured to receive the blender blade 14 and subsequently rotate with the blender blade 14 to clean the interior surfaces 23. The device 25 includes a body 30 that axially extends between a first end 32 and a second end 34. The body 30 may take any suitable shape, and in one non-limiting example, the body 30 is cylindrically shaped in use, the first end 32 is configured to face the blender blade 14 and the second end 34 is configured to face the base 12. The first end 32 is configured to receive the blender blade 14 when the blender blade 14 moves towards the base 12, and similarly, the first end 32 is also configured to disengage from the blender blade 14 when the blender blade 14 moves away from the base 12. After the first end 32 receives the blender blade 14, rotation of the blender blade 14 causes rotation of the body 30. Rotation of the body 30 cleans interior surface 33 of the splash shield 20. In some examples, it is contemplated that the body 30 will also rotate with another component of the automated blender 10, such as the base 12, or the body 30 may “self-rotate” by an internal winding mechanism, motor, and/or the like.

Brush bristles 46 may also be connected to the body 30. The brush bristles 46 are configured to contact the interior surface 23 of the splash shield 20 when the blender blade 14 and/or the body 30 rotates. The brush bristles 46 may be made out of any suitable material including plastic, hair stands, and/or the like. A plurality of brush bristles 46 may be connected to body 30 at a plurality of locations. In addition or alternately, sponges, wipers, squeegees, and/or any other material can be provided to clean the inside surface 23 of the splash shield 20.

In some examples, the first end 32 defines a recess 36 that receives the blender blade 14. At least one protrusion 38 radially extends into the recess 36. The movement of the blender blade 14 towards the base 12 and subsequent rotation of the blender blade 14 causes the blender blade 14 to engage with the protrusion 38 and thereby causes rotation of the body 30. The number and configuration of protrusions 38 can vary from that shown. In the illustrated example, a pair of protrusions 38 are radially opposed to each other. In other examples, protrusion 38 may extend out from the first end 32 toward the blender blade 14 and be configured to receive the blender blade 14. Each protrusion 38 may be the same or different material as the body 30, and the protrusions 38 may be separate from or integrally formed into the body 30.

In use, as the blender blade 14 moves toward the base 12, the recess 36 and/or protrusions 38 might be axially mis-aligned with the blender blade 14, thus causing the blender blade 14 to not be received (i.e. to be blocked), or only partially received, by the first end 32. To counteract this the recess 36 can be sized much larger than the blender blade 14 and/or the body 30 may be pivotable with respect to the axis B extending from the blender blade 14 to the base 12 such that engagement between the blender blade 14 and protrusions 38 causes the body 30 to pivot about the axis 13 into a position wherein the blender blade 14 is no longer blocked and is received by the first end 32 of the body 32.

The device 25 may also include an alignment portion 48 on and/or connected to the second end 34. The alignment portion 48 is configured to align the body 30 with respect to the blender blade 14 and/or the base 12 when the device 25 is inserted into the automated blender 10. In the illustrated example, the alignment portion 48 is a cone; however, the alignment portion 48 can be shaped to any suitable size and configuration including a rounded cone, a sphere, and/or the like. The alignment portion 48 may be integrally formed with the body 30 or a separate component of the device 25. The alignment portion 48 can be configured to minimize vibrations from the device 25 when rotating within the automated blender 10. Further, the alignment portion 48 can be configured to prevent the body 30 from moving to a non-axial position between the blender blade 14 and the base 12.

The device 25 may further include a bearing 50 having a radially inner bearing surface 52 that defines a bearing recess 54. The alignment portion 48 nests in the bearing 50 such that the alignment portion 48 abuts the radially inner bearing surface 52 and is pivotable with respect to the bearing 50. In the illustrated example, the bearing 50 includes a bearing ring 56 and a bearing housing 58. The bearing ring 56 nests in the bearing housing 58 and is removably connected to the bearing housing 58 to facilitate cleaning, replacement, and/or the like. In certain examples, the bearing housing 58 may include wing projections that radially project from the bearing housing 58 and increase contact of the bearing 50 with the base 12.

The device 25 may also include a retainer plate 60. The retainer plate 60 is coupled to the second end 34 of the body 30, and the retainer plate 60 and the body 30 are disposed on opposite sides of the bearing 50. The retainer plate 60 is sized larger than the bearing recess 54 so that the retainer plate 60 cannot pass through the bearing 50. Thus the body 30 is coupled to the bearing 50. The retainer plate 60 may be made of any suitable material and take any shape such as disc, sphere, rectangular, and/or the like. The shape of the retainer plate 60 may correspond to the shape of the bearing recess 54. For instance, the retainer plate 60 may be a disc and the bearing recess 54 is circular in cross section. Coupling the retainer plate 60 to the body 30 may bias the body 30 toward the bearing 50, keep the body 30 in a generally upright axial position between the base 12 and the blender blades 14, lower the center of mass of the body 25, and/or couple the components of the device 25 together to avoid inadvertent loss of a component.

In some examples, the retainer plate 60 may be spaced apart from the second end 34 of the body 30 so that a gap 61 exists between the retainer plate 60 and the bearing 50 when the alignment portion 48 is nested in the bearing 50. The gap 61 allows the body 30 to axially translate during the rotation of the blender blade 14 and/or the body 30. Additionally, the body 30 may be configured to axially translate during the rotation of the blender blade 14 and/or the body 30. The size of the gap 61 can be adjusted to change the location of the center of mass of the body 25 by either decreasing or increasing the size of the gap 61. In one non-limiting example, the gap 61 may be adjusted by coupling the retainer plate 80 to the body 30 with a rod haying screw threads.

The device 25 can be constructed and/or sized to fit inside the splash shield 20 of many different automated blender 10 models. Similarly, the body 30 can be constructed for each type of base 12 and/or blender blade 14. In one non-limiting example, as depicted in FIGS. 3-6, the device 25 sits in a hole defined by the base 12.

The device 25 advantageously prevents injury to the user operating the automated blender 10. Often, the blender blades 14 having sharp edges capable of causing injury. By using the rotational and/or axial movement of the blender blade 14, no direct contact between the blender blade 14 and the user is required. Further, the protrusion 38 portion may engage and/or align with the blender blade 14 without additional manual manipulation of the device 25 after it is placed in the automated blender 10. In some examples, the device 25 can be constructed to utilize the normal pre-programmed rotational and/or axial movement of the blender blade 14 in other automated blenders 10, additional programming may be required. The device 25 described herein is advantageous for use with the automated blender 10 described above, and it is contemplated that the device 25 may be applicable to non-automated blender machines which may require the user to manually connect and/or lock the device 25 to the blender blade 14, the base 12, or other non-automated blender machine components.

In the above description, certain terms have been used for brevity, clarity, and understanding. No unnecessary limitations are to be inferred therefrom beyond the requirement of the prior art because such terms are used for descriptive purposes and are intended to be broadly construed. The different devices and methods described herein may be used alone or in combination with other devices and methods. It is to be expected that various equivalents. alternatives and modifications are possible within the scope of the appended claims.

What is claimed is:

1. A device for cleaning an automated blender, the automated blender having a base for supporting a cup, a blender blade that axially moves towards and away from the base, and a splash shield that moves between a closed position enclosing the cup and an open position exposing the cup, the device comprising:
a body that axially extends between a first end and a second end, wherein in use the first end is configured to face the blender blade and the second end is configured to face the base, wherein the first end is configured to receive the blender blade when the blender blade is moved towards the base such that rotation of the blender blade causes rotation of the body, which thereby cleans an interior surface of the splash shield.

2. The device according to claim 1, further comprising a plurality of brush bristles on the body, the brush bristles configured to contact the interior surface of the splash shield when the blender blade and body rotate.

3. The device according to claim 1, wherein the first end is further configured to disengage from the blender blade when the blender blade is moved away from the base.

4. The device according to claim 3, wherein the first end defines a recess that receives the blender blade when the blender blade is moved towards the base.

5. The device according to claim 4, wherein, the body further comprises at least one protrusion that radially extends into the recess, wherein said movement of the blender blade towards the base and said rotation of the blender blade causes the blender blade to engage with the at least one protrusion, which causes said rotation of the body.

6. The device according to claim 5, wherein the at least one protrusion is one of a pair of protrusions that are radially opposed to each other.

7. The device according to claim 4, wherein the recess is sized larger than the blender blade and wherein the body is pivotable with respect to an axis extending from the blender blade to the base such that the blender blade can be received by the first end of the body despite slight axial misalignment between the blender blade and the body.

8. The device according to claim 1, further comprising an alignment portion on the second end of the body, wherein the alignment portion is configured to align the body with respect to the blender blade when the device is inserted into the automated blender.

9. The device according to claim 8, further comprising a bearing having a radially inner bearing surface that defines a bearing recess, wherein the alignment portion nests in the bearing such that the alignment portion abuts the radially inner bearing surface and is pivotable with respect to the bearing.

10. The device according to claim 9, wherein the bearing comprises a bearing ring and a bearing housing that houses the bearing ring.

11. The device according to claim 9, further comprising a retainer plate coupled to the second end of the body, wherein the retainer plate and body are disposed on opposite sides of the bearing, wherein the retainer plate is sized larger than the bearing recess so that the body is coupled to the bearing.

12. The device according to claim 11, wherein the retainer plate is spaced apart from the second end of the body so that a gap exists between the retainer plate and the bearing when the alignment portion is nested in the bearing, thereby allowing the body to axially translate during said rotation of the blender blade.

13. The device according to claim 11, wherein the retainer plate comprises a disc and wherein the bearing recess is circular in cross section.

14. The device according to claim 1, wherein the body is configured to axially translate during rotation of the blender blade.

15. A device for cleaning an automated blender, the automated blender having a base for supporting a cup, a blender blade that axially moves towards and away from the base, and a splash shield that moves between a closed position enclosing the cup and an open position exposing the cup, the device comprising:
a body that axially extends between a first end and a second end, wherein in use the first end is configured to face the blender blade and the second end is configured to face the base;
an alignment portion on the second end of the body, wherein the alignment portion is configured to align the body with respect to the base when the device is inserted into the automated blender;
a bearing having a radially inner bearing surface that defines a bearing recess, wherein the alignment portion nests in the bearing such that the alignment portion abuts the radially inner bearing surface and is pivotable with respect to the bearing;
wherein the body rotates to clean the interior surface of the splash shield.

16. The device according to claim 15 further comprising a retainer plate coupled to the second end of the body, wherein the retainer plate and body are disposed on opposite sides of the bearing, wherein the retainer plate is sized larger than the bearing recess so that the body is coupled to the bearing.

17. The device according to claim 16, wherein the retainer plate is spaced apart from the second end of the body so that a gap exists between the retainer plate and the bearing when the alignment portion is nested in the bearing, thereby allowing the body to axially translate during said rotation of the blender blade.

18. The device according to claim 1, further comprising a plurality of brush bristles on the body, the brush bristles configured to contact the interior surface of the splash shield when the blender blade and body rotate.

19. The device according to claim 15, wherein the body is configured to axially translate during rotation.

20. The device according to claim 15, bearing comprises a bearing ring and a bearing housing that houses the bearing ring.
